(19) United States
(12) Patent Application Publication
(10) Pub. No.: US 2026/0358471 A1
(43) Pub. Date: Nov. 12, 2026

(54) IMPROVED RADAR MEASUREMENT DEVICE

(71) Applicant: PPG Industries Ohio, Inc., Cleveland, OH (US)

(72) Inventors: Eldon L. Decker, Gibsonia, PA (US); David Leonardo Gonzalez Arellano, Colonia San Lorenzo (MX); Yuejun Zhao, Wexford, PA (US)

(73) Assignee: PPG Industries Ohio, Inc., Cleveland, OH (US)

(21) Appl. No.: 19/132,677

(22) PCT Filed: Nov. 20, 2023
(86) PCT No.: PCT/US2023/080496

§ 371 Date: May 23, 2025

Related U.S. Application Data
(60) Provisional application No. 63/385,330, filed on Nov. 29, 2022.

(51) Int. Cl. G01S 7/40; G01S 7/02; G01S 7/03; G01S 13/931

(52) U.S. Cl. CPC G01S 7/4039; G01S 7/024; G01S 7/027; G01S 7/03; G01S 7/4086; G01S 13/931; G01S 2013/93275

(57) ABSTRACT

Provided is a color map generation method for forming accurate color map information by matching color information and obstacle information for each pixel. The color map generation method according to an embodiment comprises the steps of: receiving a GPS signal and forming GPS data; converting a plurality of GPS coordinates included in the GPS data into image pixel coordinates; matching the image pixel coordinates with the GPS data and color information corresponding to the plurality of GPS coordinates; clustering the image pixel coordinates on the basis of the positions of the Lidar coordinates respectively corresponding to the plurality of GPS coordinates; and forming color map data corresponding to the GPS data on the basis of the clustered image pixel coordinates.

### BACKGROUND

### 1. Technical Field

The present disclosure relates to devices, computer-implemented methods, and systems for determining transmittance through a substrate optionally with coating(s) using a radar device and calibrated references.

### 2. Background

Vehicle radars may be installed behind painted bumpers or painted body panels for purposes of aesthetics, aerodynamics, or to provide environmental protection from precipitation or debris. The radars may be provided at various locations around a vehicle to detect other vehicles, pedestrians, or other objects. Radars may be used to warn drivers regarding vehicles in their blind spot and/or lane changes, to provide collision avoidance, to regulate speed and/or following distance, etc.

To function reliably, the painted bumper or painted panel material covering the radar should have a transmittance within the specification range for the radar. Thus, when repairs are made to replace parts of the vehicle, such as a bumper cover or body panel, characterization of the transmittance may be needed to determine that the transmittance is within the design specification. This also may be the case if a vehicle or a vehicle part such as a bumper cover or body panel is repainted or refinished.

Conventional radars used in vehicles transmit a wide-angle beam, which when used to characterize the transmittance has undesirable effects wherein a small portion of the emitted signal is returned to the area of the receiver of the radar, reducing the detected signal. Further, the wide-angle beam can result in a significant signal due to extraneous backscatter, increasing the noise. Both the reduced signal and the increased noise have a disadvantageous effect on the signal-to-noise ratio. Further, conventional automotive radar devices operate over a limited range of frequencies, limiting their ability to fully characterize the bumper or body panel.

Accordingly, there are several problems in the art that can be addressed.

### BRIEF SUMMARY OF THE DISCLOSURE

The present disclosure provides systems, methods, and apparatuses configured to determine transmission loss through a sample (e.g., dielectric substrate and coating). For example, systems of the present disclosure may include a radar system, which includes at least a transmitter and receiver in various orientations and positions optimized to emit and detect radar transmissions reflected from and/or received through a given sample. The disclosure enables various advantages, including various improvements that enable larger signal-to-noise ratios and better calculations of the transmittance of radar through the sample.

For example, a radar device can include a transmitter configured to emit a diverging beam of electromagnetic radiation having a wavelength greater than one millimeter, wherein the diverging beam is emitted along a transmission path to a sample. The radar device can also include a first calibrated reference arranged downstream from a location of the sample, the first calibrated reference configured to reflect the directed beam to a return path that is substantially antiparallel to the transmission path to the sample, the return path passing back through the location of the sample. In addition, the radar device can include a receiver arranged on a same side as the transmitter relative to the location of the sample, the receiver configured to measure reflected electromagnetic radiation that has been reflected along the return path, the receiver generating a first measurement value representing a power of the measured electromagnetic radiation. Furthermore, the radar device can include a processor configured to calculate a transmittance through the sample based on the first measurement value.

In additional or alternative examples, a radar device can include a transmitter configured to emit a diverging beam of electromagnetic radiation having a wavelength greater than one millimeter. The diverging beam is emitted along a transmission path to a sample, the sample having a front surface and an opposed, rear surface. The radar device can also include a receiver arranged adjacent the rear surface the sample. The receiver may be configured to measure transmitted electromagnetic radiation that has been transmitted through the front and rear surfaces of the sample, the receiver generating a first measurement value representing a power of the measured electromagnetic radiation transmitted through the sample. Furthermore, the radar device can include a processor configured to calculate a transmittance through the sample based on the first measurement value.

The present disclosure also provides a method that can include emitting a diverging beam of electromagnetic radiation from a transmitter, the electromagnetic radiation having a wavelength greater than one millimeter. The method can also include directing the diverging beam along a transmission path to a sample at a location. In addition, the method can include reflecting the electromagnetic radiation from a first calibrated reference arranged downstream from the location of the sample, the first calibrated reference configured to direct the reflected electromagnetic radiation to a return path that is substantially antiparallel to the transmission path, the return path passing through the location of the sample. Furthermore, the method can include detecting the reflected electromagnetic radiation using a receiver arranged on a same side as the transmitter relative to the location of the sample, the receiver configured to measure reflected electromagnetic radiation that has been reflected along the return path, the receiver generating a first measurement value representing a power of the measured electromagnetic radiation. Still further, the method can include calculating, using a processor, a transmittance through the sample based on the first measurement value.

Yet still further, the present disclosure provides computer program products that perform each of the functions discussed for the above-noted systems, methods, and apparatuses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a diagram of a radar system, in accordance with the present disclosure;

FIG. 1B illustrates a forward path of an incident beam through the radar system, in accordance with the present disclosure;

FIG. 1C illustrates a return path of a reflected beam through the radar system, in accordance with the present disclosure;

FIG. 1D illustrates an alternate example of the system shown in FIGS. 1A-1B, in which two radar systems are positioned about the sample, in accordance with the present disclosure;

FIG. 1E illustrates an alternative schematic implementing a gain horn antenna, in accordance with the present disclosure;

FIG. 1F illustrates a schematic for using a self-alignment tool in accordance with the present disclosure;

FIG. 2A illustrates a diagram of a background reference in a first orientation with a first reference material toward a radar in accordance with the present disclosure;

FIG. 2B illustrates a diagram of the background reference in a second orientation with a second reference material toward the radar, in accordance with the present disclosure;

FIG. 3A illustrates a diagram of the radar system using polarization, in accordance with the present disclosure;

FIG. 3B illustrates a diagram of the radar system using a reflector to collimate the radar beam, in accordance with the present disclosure;

FIG. 3C illustrates an integrating sphere for use in accordance with the present disclosure;

FIG. 3D illustrates a ray diagram showing an angular reflected radar power setup with the sample held perpendicular to the radar emitter direction;

FIG. 3E illustrates another ray diagram showing an angular reflected radar power setup with the sample held at a non-perpendicular angle between the normal to the sample surface and the radar emitter direction;

FIG. 3F illustrates a plotted table of values showing radar power measured over angles relative to the specular direction using materials to be used for the interior surface of a radar integrating sphere in accordance with the present disclosure;

FIG. 3G illustrates another table of values showing radar power, plotted on a log scale, measured using materials to be used for the interior surface of a radar integrating sphere in accordance with the present disclosure over angles relative to the specular direction;

FIG. 4A illustrates a flow diagram of a first example of a method of determining transmission through a sample, in accordance with the present disclosure;

FIG. 4B illustrates a flow diagram of a second example of a method of determining transmission through a sample, in accordance with the present disclosure;

FIG. 5A illustrates a plot of transmission versus frequency for one frequency measurement, in accordance with the present disclosure;

FIG. 5B illustrates a plot of transmission versus frequency for a range of frequency measurements from 76 GHz to 81 GHz, in accordance with the present disclosure;

FIG. 5C illustrates a plot of transmission versus frequency for a range of frequency measurements from 60 GHz to 90 GHz, in accordance with the present disclosure;

FIG. 6 illustrates a block diagram of a radar device, in accordance with the present disclosure; and

FIG. 7 illustrates a block diagram of a radar processor, in accordance with the present disclosure.

### DETAILED DESCRIPTION

The present disclosure provides systems, methods, and apparatuses configured to determine transmission loss through a sample (e.g., dielectric substrate and coating) using a radar, which includes at least a transmitter and receiver on one side of the sample and respective references on the other side of the sample. The electromagnetic signal from the radar is transmitted through the sample, reflected from the known reference, such as a calibrated reference, and then transmitted back through the sample, before finally being detected by the receiver of the radar. Measuring reflected signals for one or more different known references allows the transmittance of the sample to be calculated from just reflectance measurements, without requiring a detector on the other side of the sample to directly measure the transmittance. Various improvements to the radar enable larger signal-to-noise ratios and better calculations of the transmittance, including an aperture and/or baffling that blocks extraneous signal, collimating the radar beam to increase the return signal, selecting a distance between the sample and reference that mitigates etalon effects, and measuring the reflected energy/power over a range of frequencies.

As discussed above, many automobile and original equipment manufacturers (OEM) produce vehicles and radar systems in which the radar system is located behind a dielectric substrate, such as a bumper cover or body panel of the vehicle. To ensure functionality within the radar system tolerances, the transmission through the dielectric substrate should be within design specifications. The present disclosure addresses a need to characterize the transmission through the dielectric substrate (e.g., a sample 150) to verify that it is within specifications, which provides significant advantages both for manufacturers and OEMs and well as for body shops and paint/coating refinishers. As discussed below, the dielectric substrate can be painted or otherwise have an external aesthetic coating, including, e.g., a primer, a base coat, and a clear coat, which are additional dielectric layers. Due to absorption, reflection, and etalon effects, the thickness of the additional dielectric layers together with their real and imaginary dielectric coefficients (also known as real and imaginary parts of the relative electric permittivities) will impact the transmission, and therefore should also be accounted for. The radar system disclosed herein and the methods of operating the radar system, which methods are also disclosed herein, address the above-noted needs by providing an efficient and cost-effective solution for determining the transmission through samples, such as a vehicle bumper cover or panel.

As illustrated in certain examples of the disclosure herein, the radar system can be a handheld radar measurement device or a table-top radar measurement device including, e.g., a radar emitter (transmitter) and radar detector (receiver) as well as a signal processor, such as a computer processing unit (CPU) or a digital signal processor (DSP) that can evaluate the output energy/power and input energy/power to calculate the reflectance, transmittance, and/or the radar loss in units of dB for the radar signal. Upon being transmitted from the radar measurement device, the radar signal passes from the emitter (transmitter), through the sample, reflects off of the background reference behind the sample (or not if the reference is perfectly absorbing) and the reflected signal returns back through the sample to the detector (receiver), where the energy/power of the reflected signal is measured.

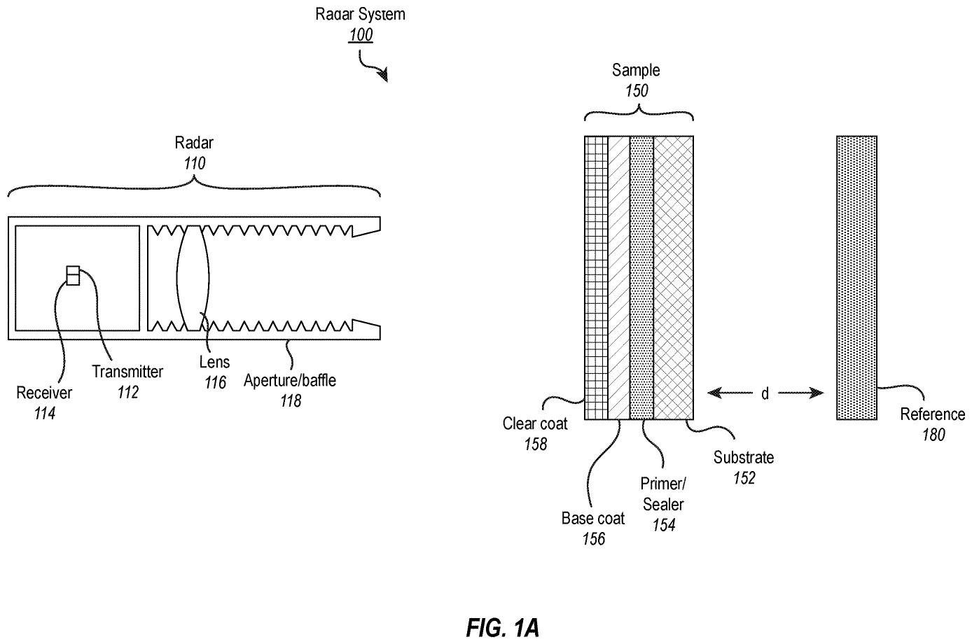

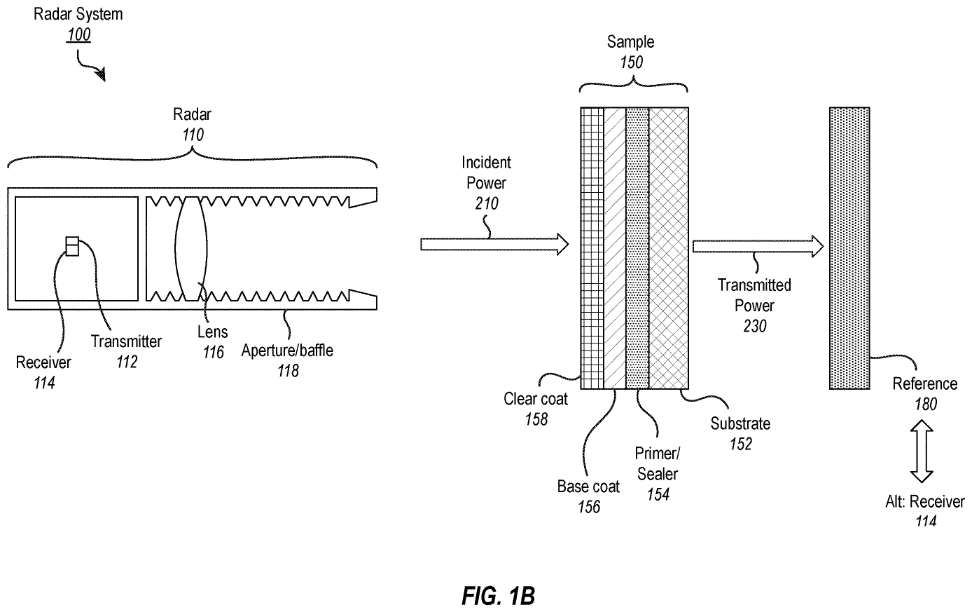

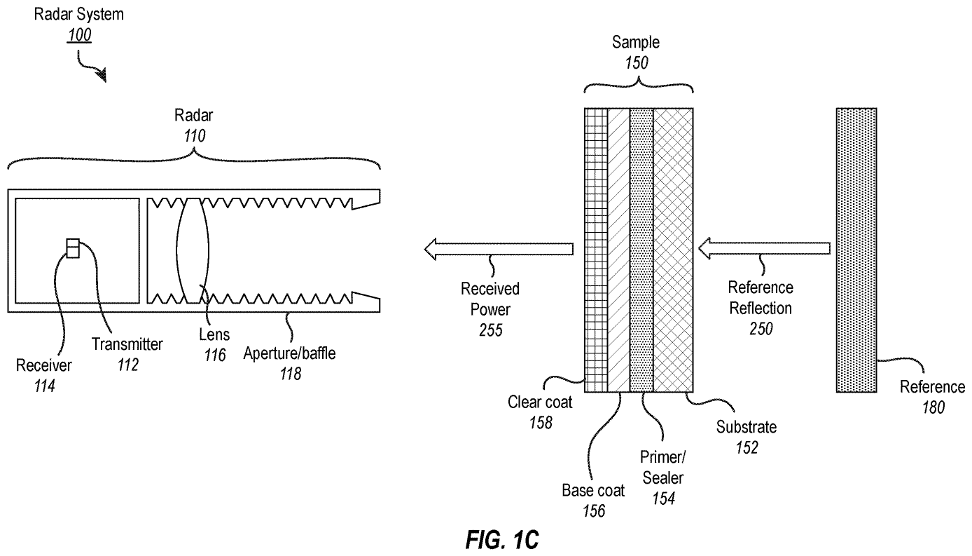

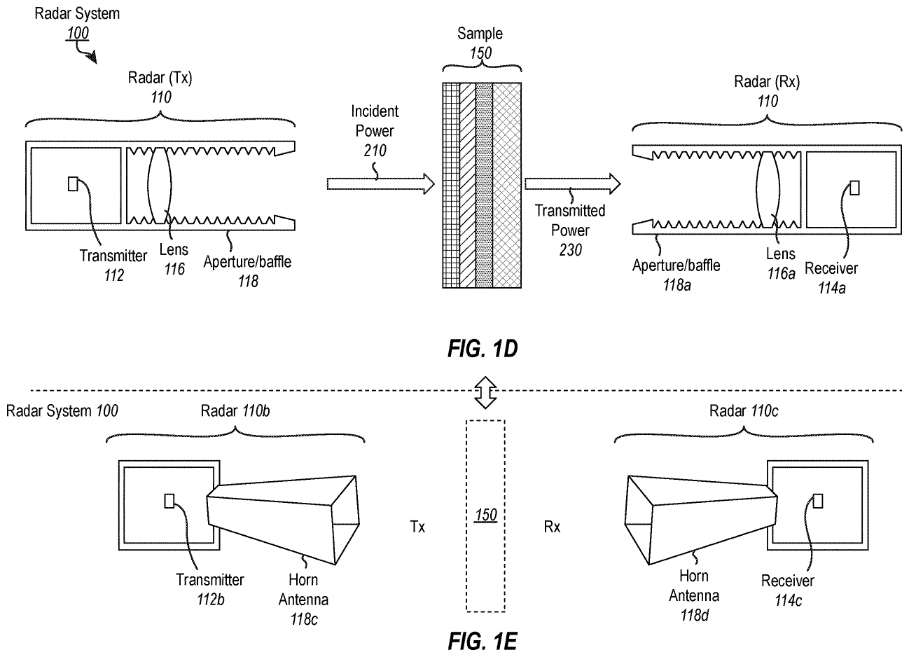

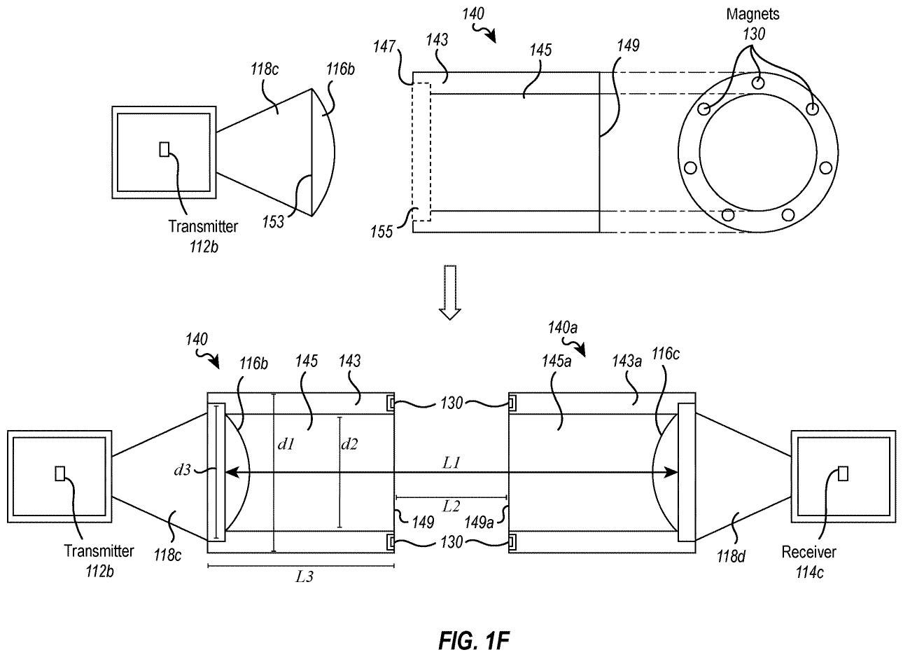

Reference is first made to FIG. 1A, which shows a diagram of a radar system 100, having a radar 110 and a reference 180 arranged to reflect the electromagnetic radiation from the radar 110 back to the radar 110 where the reflected energy/power is detected. The radar system 100 also has a location between the radar 110 and the reference 180 for measuring and calculating transmittance of a sample 150. In the example disclosed in FIG. 1A, the sample 150 has four layers: a substrate 152, a primer/sealer 154, a base coat (BC) 156, and a clear coat (CC) 158. A person of skill in the art will understand that other samples with different numbers of layers can be used. The sample 150 is shown in FIG. 1A to provide context. Further, the one-way transmission through the sample is independent of the orientation of the sample 150. Accordingly, the sample can be flipped 180 degrees, with the substrate 152 then facing the radar 110 rather than facing the reference 180, without affecting the results of the measurements described herein. For purposes of description, the sample 150 will be understood as having a front surface (e.g., clearcoat layer 158) that faces the transmitter, and an opposing rear surface (e.g., substrate layer 152), which in the case of FIG. 1A faces, or is adjacent, reference 180.

FIG. 1A shows that the radar 110 includes a transmitter 112 and a receiver 114. The transmitter 112 emits a diverging beam, which is collimated by the collimating element 116, such as a convex lens. As used herein and in the claims, the term “collimated” means that the beam divergence angle is in the range of 0-12 degrees. The collimated beam propagates along a collimating element in the form of aperture/baffle 118, which is a structure that limits the solid angle of the radar beam exiting and entering the radar 110. This improves the signal-to-noise ratio by limiting extraneous and background signals. The lens/collimating element 116 and aperture/baffle 118 combine to comprise a “beam directing element.”

In one example, the receiver 114 performs coherent detection of the reflected signal. In another example, the receiver 114 performs incoherent detection of the reflected signal. In certain examples disclosed herein, the receiver 114 detects both the amplitude and phase of the reflected signal, and, in other examples disclosed herein, the receiver 114 detects only the energy/power of the reflected signal.

FIG. 1B illustrates the outward path of the beam emitted from the radar 110. As shown, the collimated beam from the radar 110 impinges the sample 150 with the incident energy/power 210. Part of the incident power is reflected from the sample 150 as the received power (FIG. 1C). Part of the incident power 210 is absorbed in the sample 150. The remainder part of the incident energy/power 210 is transmitted through the sample 150 as the transmitted energy/power 230. FIG. 1B further shows that, alternatively, reference 180 may instead comprise a receiver 114 positioned at the other side of sample 150. In the case that receiver 114 is on the substrate side 152, then receiver 114 would receive the transmitted power 230.

Returning to the case where element 180 is a reference sample, FIG. 1C further illustrates the return path of the reflected radar beam from the reference 180 to the radar 110. (Incident power 210 is assumed in this case, but not illustrated). The reference reflection energy/power 250 is a part of the transmitted energy/power 230 that is reflected from the reference 180 to the radar 110. Then, a part of the reference reflection is transmitted back through the sample 150 with the arrow labeled “received power 255,” which includes both the reference reflection 250 from the reference as well as any reflection from the sample 150 itself. Thus, this transmitted part is contained within the received energy/power 255 that returns to the radar 110, and is then detected by the receiver 114 as the measured reflectance or “Rₘ” (below).

The following discussion provides exemplary equations used to determine the transmittance through the sample 150. The measured reflectance Rₘ of the radar energy/power can be the received energy/power divided by the emitted energy/power, while accounting for geometrical losses. For example, the measured reflectance Rₘ can be relative to an ideal reflector that reflects essentially all incident energy/power. For the combination of the sample together with a known reference, the measured reflectance Rₘ of the radar energy/power is given by the expression:

$${R}_{m} = {R}_{s} + \frac{{T}_{s}^{2} {R}_{b}}{( 1 - {R}_{s} {R}_{b} )} ,$$

In the above equation, Rₘ is the reflectance from both the sample 150 and the reference 180, while Rₛ is the reflectance of only the sample 150. In addition, Tₛ is the transmittance of the sample 150, and R_{b} is the reflectance of only the reference 180. Generally, the reflectance R_{b} of the reference 180 is known because it can be measured previously in a calibration step by measuring the reflected energy/power in the presence of the reference 180. If the reflectance Rₛ of the sample 150 is measured as well as the reflectance Rₘ, and the reflectance R_{b}, then transmittance Tₛ of the sample 150 can be calculated from the equation above. If, however, Rₛ of the sample 150 cannot be measured accurately alone, then that leaves two unknowns for which to solve: (1) the reflectance Rₛ of the sample 150 and (2) the transmittance Tₛ of the sample 150. Solving for two unknowns can be performed using two equations. Accordingly, the reflectance can be measured using a second reference, with the measured reflectance given by

$${R}_{m , i} = {R}_{s} + \frac{{T}_{s}^{2} {R}_{b , i}}{( 1 - {R}_{s} {R}_{b , i} )} ,$$

wherein R_{m,i} is the measured reflectance in the presence of the sample 150 and the i^{th} reference 180, and R_{b,i} is the reflectance of the i^{th} reference 180, which is known due to a prior calibration.

For example, good results can be obtained when R_{b,1} is very different than R_{b,2}. Consider performing a measurement to get R_{m,1} with a highly reflective reference behind the sample, and performing a measurement to get R_{m,2} with a highly absorptive reference behind the sample. Then, the two equations:

$${R}_{m , 1} = {R}_{s} + \frac{{T}_{s}^{2} {R}_{b , 1}}{( 1 - {R}_{s} {R}_{b , 1} )} and$$

$${R}_{m , 2} = {R}_{s} + \frac{{T}_{s}^{2} {R}_{b , 2}}{( 1 - {R}_{s} 2 )}$$

can be solved to determine two unknowns: Rₛ and Tₛ. Thus, the one-way radar loss can then be calculated from Tₛ from the equation:

1-way loss (dB)=10 log₁₀(1/Tₛ),

wherein Tₛ is a transmittance value (from 0 to 1) not a percent transmittance (from 0 to 100).

In another example, one or both references can be selected to be Lambertian scatterers or diffuse scatterers to reduce an effect of angular misalignment of the references that can occur when the references are specular scatterers. Additionally, one or both of the references can be shaped as a corner cube to reduce an effect of angular misalignment of the references.

In another example, one or both references can be adhesive films, which can be at least temporarily adhered to the opposite side of the sample 150 from the radar 110, so that no air gap exists between the sample and the reference. This is especially helpful when the sample is not perfectly flat, so that the reference can conform to the shape of the sample, or when there is not sufficient room for a sufficiently large air gap between the sample and the reference.

The radar system 100 can include several features to improve functionality. The aperture/baffle 118 can be a conduit or channel, such as a tube from the radar 110 made of an absorbing/opaque material at the radar wavelength that covers at least a portion of the inner surface of the conduit or channel. This can reduce contributions in the measured return signal due to spurious reflections causing noise in the return signal. Thus, the return signal is predominantly due to plane-parallel radar signals that are transmitted through the sample, thereby decreasing the noise from spurious reflections and scattering from the sample itself and/or surrounding objects.

To further increase the plane parallel nature of the radar wave signal, a collimating element 116 (e.g., a convex lens) can be positioned along the path of the radar beam, after the transmitter 112, to collimate the beam. Use of the collimating element 116 can further reduce noise, and can increase detected signals relevant to the sample measurement by delivering a significant majority of the radar beam into a defined area of the sample 150. In addition, because the radar beam is collimated, a significant majority of the radar beam may be collected by the receiver on the opposing side (e.g., FIG. 1B, where reference 180 is replaced by an alternate receiver) to assist a calculation of transmittance through sample 150. In one possible alternative, one could still have a receiver 114 within radar 110 on the signal generating side to measure a signal of the reflected energy/power. Thus, in such an alternate case, there may be a receiver on both sides of the sample, if desired.

FIG. 1D illustrates an alternate example of the radar system 100 shown in FIGS. 1A-1C, in which two radar systems 100 and 100a (one at least comprising a transmitter and one at least comprising a receiver) are positioned about the sample 150 on opposite sides, in accordance with the present disclosure. For example, as noted above, another radar system 110a, essentially identical in some or all respects to radar 100, except directed to reception rather than transmission, may be positioned an optimizable distance from the sample 150 on an opposing rear surface of the sample. To this point, FIG. 1D shows that alternate radar 110a, like radar 110, includes a receiver 114a, a lens 116a, and an aperture/baffle 118a. One will appreciate that the self-alignment tool 140 and 140a (FIG. 1F) may be used and/or adjusted for use with one or multiple of the radar device setups disclosed herein.

FIG. 1D shows that the user may position radar 110a in line with radar 110 so that the transmitter 112 of radar 110 directly lines up with receiver 114a of radar 110a. With a receiver 114a positioned directly behind (or on the opposite side/surface of) the sample 150, the receiver 114a can be used in the direct transmission path with transmissions from radar 110 to more accurately measure transmittance of the radar signal (from transmitter 112) through sample 150. The user may optimize the capture of the transmitted signal by varying or otherwise optimizing the position of the aperture/baffle 118a adjacent sample 150. In at least one configuration, the alternate receiving radar 110a need not employ a baffle 118a or lens 116a, as mentioned above for FIG. 1C. Similarly, the alternate receiving radar 110a may employ an aperture/baffle 118a but not a lens 116a, or may employ a shortened aperture/baffle 118a (compared to what is illustrated) along with lens 116a, and without transmitter 112a. In still further configurations, the alternate radar 110a may comprise an aperture/baffle 118a and receiver 114a, but no lens 116 or transmitter 112a, and so on.

FIG. 1E illustrates still further alternatives for focusing and receiving the transmitted radar signals through a sample. In particular, instead of the collimating system shown in FIGS. 1A-1C (and elsewhere, herein) using a collimating lens 116 and aperture/baffle 118/118a, etc. to focus the signal, the radar system 100 can alternately employ a beam directing element in the form of a gain horn antenna, such as the illustrated horn antenna 118c. In this alternate configuration, the horn antenna 118c may still be connected to a transmitter 112b, receiver 114b, or only one or the other, or both transmitter and receiver, as needed, and depending on position relative to sample 150. The horn antenna 118c may include a lens 116 in at least some examples. Still further examples include the use of a waveguide (not shown) to direct the beam before being transmitted via the horn antenna 118c. Thus, a beam directing element in the context of FIGS. 1E-1F may include a horn antenna 118c, and may further include one or both of a lens.

In the illustrated case, radar system 100 includes a horn-based radar 110b on the transmit side of sample 150 with a corresponding horn antenna 118c, and similarly a receiver oriented radar 110c with a horn-based antenna 118d on the receive side of sample 150. Accordingly, one will appreciate that the radar systems 110 illustrated in FIG. 1E may comprise any number or arrangement of components as necessary to accomplish the transmit/receive objectives outlined herein. In addition, one will further appreciate that the shape of the horn antenna 118c may comprise any number of possible shapes configured for directing the emitted beam. For example, FIG. 1E illustrates the horn antenna 118c/118d as a more common, pyramidal structure. The horn antenna 118c/118d may alternatively be conical shaped.

For example, FIG. 1F illustrates a schematic for using a self-alignment tool 140 in accordance with at least one aspect of the present disclosure based on a conically-shaped version of horn antenna 118c. One will appreciate that aspects of the self-alignment tool may be modified and applied to other configurations, such as the beam directing elements shown in FIGS. 1A-1D, and elsewhere herein; nevertheless, the following discussion focuses on use with a horn antenna. As shown, the self-alignment tool 140 can comprise a proximal end 147 and a distal end 149. A user can assemble the proximal end 147 to a distal end of the horn antenna 118c. For example, the self-alignment tool 140 may comprise a fitting portion 155, which may comprise a cavity, notch, or other elements or cavities shaped to the distal end (i.e., larger, projecting end) 153 of the horn antenna 118c. In particular, FIG. 1F further shows that distal end 153 of antenna 118c may fit (e.g., snugly, shape-conforming) within the fitting portion 155 of the self-alignment tool 140.

FIG. 1F further shows that the self-alignment tool 140 may comprise an outer wall having a thickness defined as the difference between d1 and d2. In particular, FIG. 1F shows that self-alignment tool 140 can comprise inner section or cavity 145 that comprises an open space defined in diameter by distance d2, the diameter between the inner surfaces of the walls 143, 143a. The variations of diameters and shape of the element 140 may vary depending on the shape of the gain horn, and it is not necessary in each example that the sections be shaped as illustrated. For example, FIG. 1E shows a traditional gain horn antenna that is pyramidal in shape, whereas the self-alignment tool 140 shown in FIG. 1F is essentially tubular in cross-section. However shaped or configured, the self-alignment tool 140 and radar 110 (with beam directing elements in the form of collimator, horn antenna, or the like) need only have reciprocating shapes at the corresponding distal or proximal ends where they mate with the tool 140.

In one exemplary aspect, the self-alignment tool 140 (e.g., shown by the illustrated half portion thereof) may comprise two alignment pieces of halves, namely sections 140 and 140a. The two sections 140, 140a can be designed to be a replica of the other, differing only in dimension sufficient to enable alignment. In one example, each alignment section 140, 140a may comprise a tubular (or other appropriately-shaped) section that may be made of any number of suitable materials, including but not limited to any synthetic or naturally occurring plastic, rubber, or metal materials, including composites thereof. In at least one example, self-alignment tool sections 140, 140a may comprise a plastic material, such as polycarbonate. Moreover, a manufacturer may employ any number of shapes and/or dimensions suitable for handling and focusing a given, transmitted electromagnetic (e.g., radar) beam. In one example, the outer diameter of the walls 143 (and/or 143a) may a total diameter “d1” of 3 inches, while the internal diameter forming cavity 145 (and/or 145a) has an inner diameter “d2” of 2 inches. Moreover, the fitting portion 155 may have a separate diameter essentially comprising a notch milled from the wall 143, 143a. For example, the fitting portion 155 may comprise a diameter “d3” of 2.52 inches, or any other appropriate length given the depth, shape, and orientation of the distal end 153 of horn 118c.

In addition, in at least one example, the length of each half of the self-alignment tool (i.e., where tools 140, 140a each comprise a “half” of the total length) may be any appropriate length needed to facilitate alignment while continuing to promote sending and receiving of radar signal. In one example, the length of the self-alignment tool 140 (or half length, as illustrated) has a total length “L3” of from 1 inch to 4 inches, preferably 1.95 inches. In one example, a length of 1.95 inches allows achieving the optimal distance of twice the focal length “L1” (e.g., 3.4 inches) between the lenses (e.g., 116, 116a, or 116b, 116c, as applicable) using a spacer (or assumed distance) between the alignment tool portions 140, 140a given by the sample 150, or “L2” at 0.1 inches. For example, a typical sample 150 may have a total thickness from 0.05 inches to 0.2 inches, preferably 0.1 inches. One will appreciate, however, that a manufacturer may vary the thickness of the spacer during alignment/testing to correspond to the actual thickness of the sample 150 being measured.

In addition, FIG. 1F shows that each distal end 149, 149a of self-alignment tool portions 140, 140a may comprise a plurality of magnets 130 nested therein. For example, FIG. 1F shows that an opposite side of the fitting portion 155 may comprise a plurality of magnets 130 that enable alignment and magnetic binding between tools 140, 140a. In one example, a manufacturer may position a plurality of blind holes (e.g., holes that are not drilled all the way through a material) on the distal ends 149, 149a of the alignment portions 140, 140a to fit various magnets, such as neodymium magnets. In one example, the magnets 130 comprise a diameter of 10 mm and a depth of 3 mm, and essentially flush with the open face of the corresponding distal end 149, or 149a, etc. As such, the corresponding self-alignment tools 140, 140a provide an alignment that is sandwiching the spacer or the sample 150, as applicable. In one example, a manufacturer may position any number of magnets, anywhere from 1 to 20 magnets, or from 2 to 18 magnets, from 5-12 magnets, or in at least one example a total of 8 magnets. In any case, the manufacturer will generally evenly distribute the magnets 130 along the circumference of each distal end 149, 149a. The magnets 130 are further aligned and positioned to match (i.e., provide opposites of) polarity between the tools 140, 140a.

### Example Measurements with a Self-Alignment Tool

In one example, a direct comparison was made between a standard measurement of radar loss using a standard focused beam setup, and a measurement using the described self-alignment tool(s) 140, 140a. The two setups were compared using 3 distinct samples (150). A first sample 1 was made using a 4″×6″ thermoplastic polyolefin panel, while a second sample 2 was a different 4″×6″ thermoplastic polyolefin panel, and third sample 3 was a 4″×6″ thermoplastic polyolefin panel painted with an automotive refinish basecoat with a silver color containing aluminum flake pigments, and a clear coat. For the control measurements, the 3 samples were measured in standard mode without the self-alignment tool.

For each test sample, the two halves of the self-alignment tool (140, 140a) were brought together on opposite sides of each one of the samples, where the self-alignment was achieved through the attraction of the magnets 130 embedded in the two halves of the tool. The radar transmission was measured over the frequency range of 63-90 GHz. For the measurement of the radar loss through air only, a circular spacer with a hole in it, the same size as the measurement area of the self-alignment tool, was used to separate the two halves of the alignment tool, by about the same thickness as the samples. The use of the air-only measurement and sample measurement gives the radar loss for the sample. The measurement with the alignment tool was compared to the measurement taken with our standard focused beam set up for each sample, and was found to be in very good agreement, to within about 0.1 dB (Table 1).

TABLE 1
Comparison of radar loss at 76.5 GHz measured
with and without the self-alignment tool.

Loss (dB)

| | 76.5 | Difference |
|---|---|---|
| Code | GHz | (dB) |
| Sample 1 | 0.326 | |
| Sample 2 | 0.507 | |
| Sample 3 | 3.465 | |
| Sample 1 (alignment tool) | 0.357 | −0.03 |
| Sample 2 (alignment tool) | 0.529 | −0.02 |
| Sample 3 (alignment tool) | 3.584 | −0.12 |

Referring again to any of the given beam focusing tools (e.g., collimator and lens, or gain horn, etc.) it may be desirable to minimize or eliminate etalon effects, which may create undesirable signal variations in the return signal, the separation distance d between the second surface of the sample 150 and the first surface of the reference 180 can be carefully chosen. In one case, the separation distance d between the sample 150 and the reference 180 shown in FIG. 1A can be set to a length less than 1/400^{th} of a wavelength; a length less than 1/600^{th} of a wavelength; or a length less than 1/1000^{th} of a wavelength. Preferably the separation distance d between the sample 150 and the reference 180 shown in FIG. 1A can be set as close as possible to a length of zero. When the separation distance d between the sample 150 and the reference 180 cannot be made small, etalon effects can be mitigated by introducing a permittivity matching material such as an adhesive with a permittivity that approximates that of the sample surface closest to the reference, that can be arranged between the sample 150 and the reference 180. For example, the reference 180 can be temporarily adhered to the second side of the sample 150 so that it is flush with the sample. Alternatively, interference resulting in etalon effects can be mitigated by making the separation distance d large enough that the spatial coherence of the beam mixes up the coherent interference that would otherwise give rise to etalon effects.

Alternatively, when the separation distance d between the sample 150 and the reference 180 cannot be made small, etalon effects can be suppressed by elements that induce spatial incoherence. In certain examples, to mitigate etalon effects, the separation distance d is much larger than the thickness of the sample 150 and ten times or larger than the wavelength of the radar beam (e.g., the separation distance d can be 4 cm, or 6 cm, or such as 10 cm or more). Preferably, the separation distance d is not too large, because that would result in loss of signal and/or spurious signals. Preferably, the separation distance d is smaller than one meter, for example.

### Focused Beam Radar Setup

The radar transmission loss was measured as a function of frequency from 63 to 90 GHz using: a signal generator (SMA100B (with SMAB-B92/SMAB-B120), Rohde & Schwarz GmbH & Co. KG.), a six times multiplier (SMZ90, Rohde & Schwarz GmbH & Co. KG.), a thermal waveguide power sensor (NRP90TWG, Rohde & Schwarz GmbH & Co. KG.), two E-band spot-focusing lens antennas with 1.7 inch focal length (SAQ-813017-12-S1, Sage Millimeter), and a Coax cable, 3.5 mm Male to 3.5 mm Male (FM160FLEX, Fairview Microwave). The two lenses are connected to the emitter (six times multiplier) and the detector (the power sensor), with the lenses facing each other. The lenses (e.g., 116) may be aligned along their axis, with their separation being about twice their focal length (3.4 inches) and with this separation adjusted to ensure maximum free space radar transmission, with no sample between the lenscs. Then, with this setup, a sample may be measured by securing it between the lenses, with the surface of the sample that is facing the detecting lens being placed at a distance of 45 mm from the detecting lens. The radar loss in dB is calculated at each frequency from Radar Loss (dB)=free space transmission (dBm)-sample transmission (dBm). The curve of radar loss vs. frequency is smoothed using a spline fit to reduce noise.

### Angular Reflected Radar Power Setup

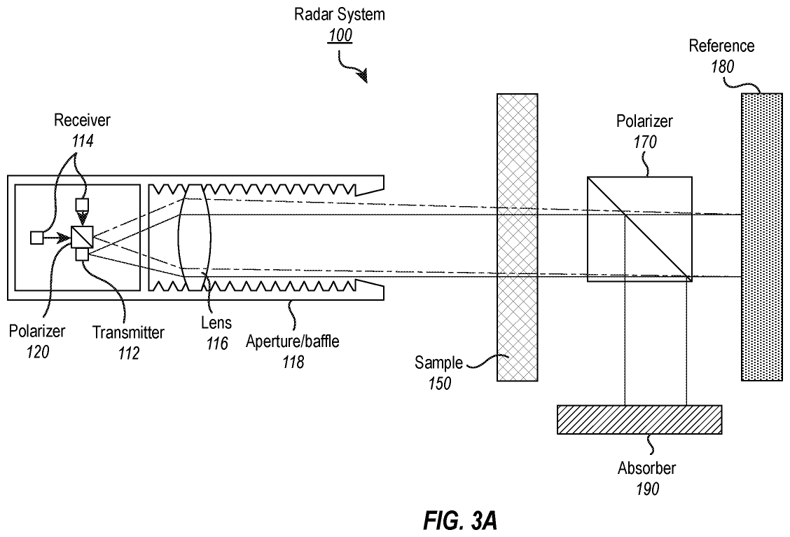

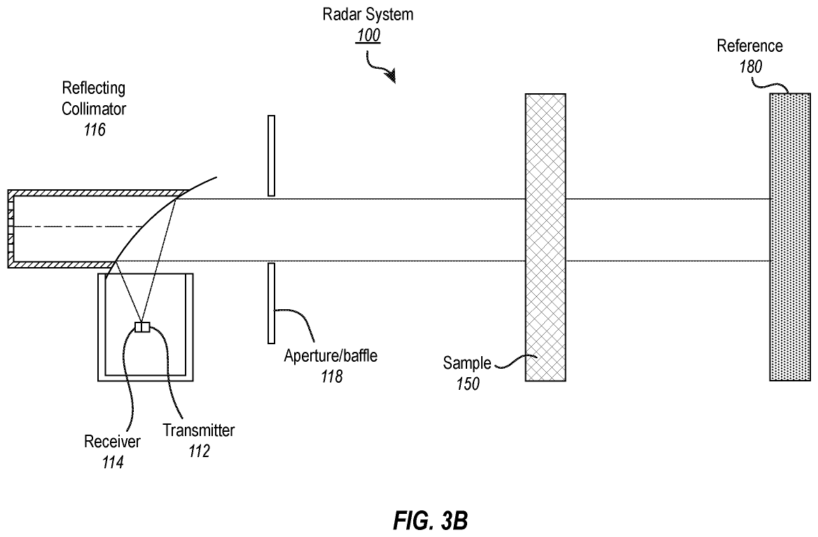

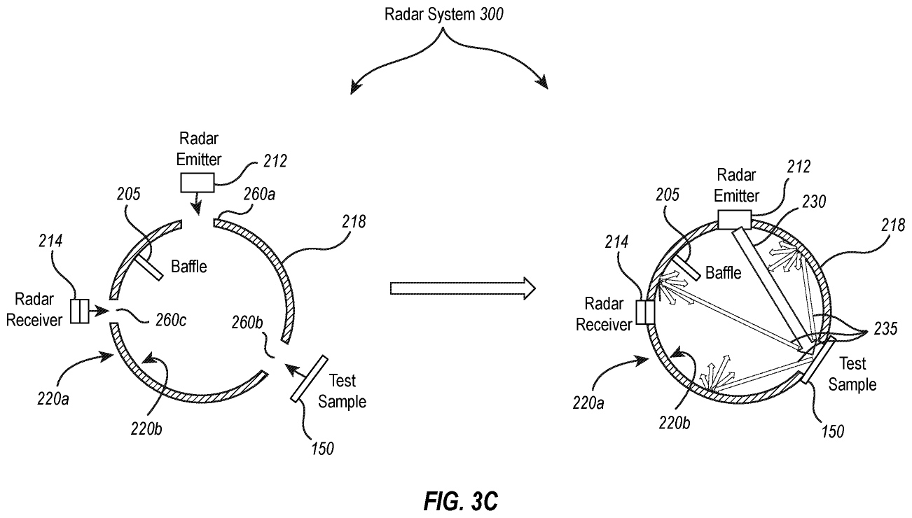

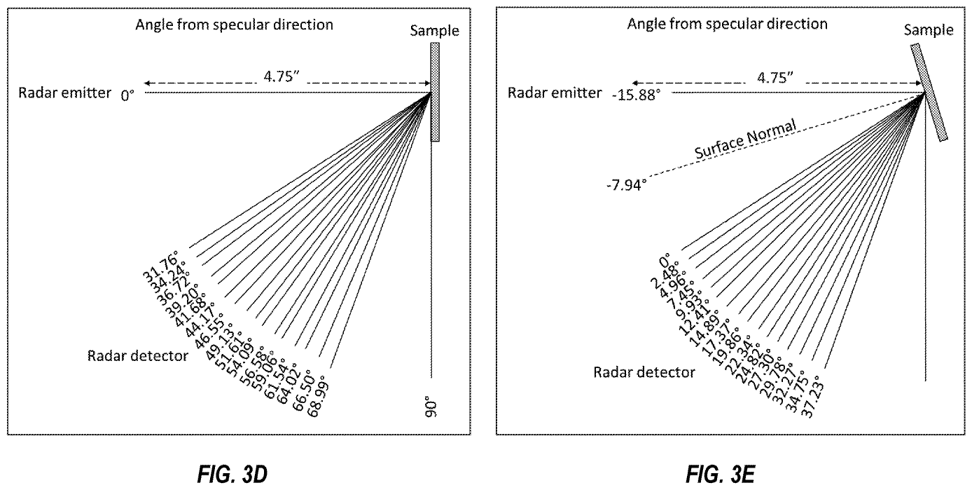

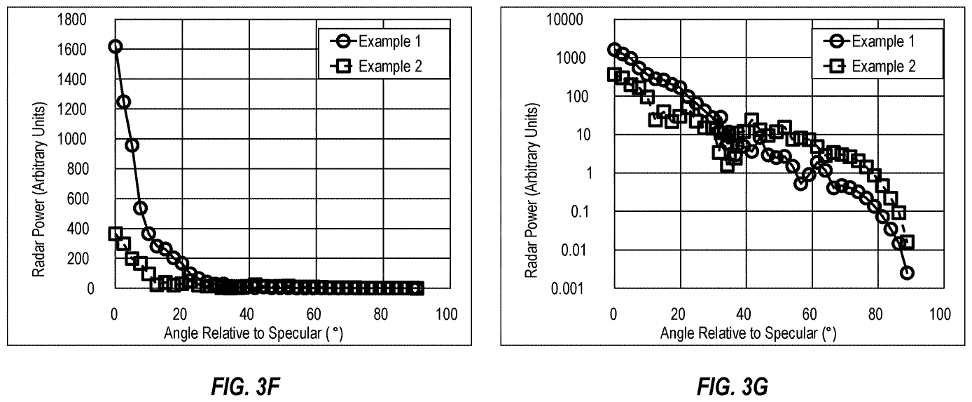

FIG. 3D illustrates angular reflected radar power setup with the sample held perpendicular to the radar emitter direction, while FIG. 3E illustrates angular reflected radar power setup with the sample held at an angle of 7.94° between the normal to the sample surface and the radar emitter direction.

The reflected radar power was measured as a function of angle at 76.5 GHz using: a signal generator (SMA100B (with SMAB-B92/SMAB-B120), Rohde & Schwarz GmbH & Co. KG.), a six times multiplier (SMZ90, Rohde & Schwarz GmbH & Co. KG.), a thermal waveguide power sensor (NRP90TWG, Rohde & Schwarz GmbH & Co. KG.), two pyramidal horn antennas (SAR-2013-12-S2, Sage Millimeter), and a Coax cable, 3.5 mm Male to 3.5 mm Male (FM160FLEX, Fairview Microwave). One horn antenna (e.g., FIGS. 1E, 1F) was connected to the 6 times multiplier as the emitter, and the other was connected to the thermal waveguide power sensor as the receiver. A sample was placed at 4.75 inches from the emitter horn and 4.75 inches from the detector horn as shown in FIGS. 3D and 3E. The angle between the detector horn and the emitter horn could be varied between about 32° to 69° as shown in FIG. 3D. The sample could be rotated from being perpendicular to the emitter direction to having an angle of 7.94° between the normal to the sample surface and the emitter direction as shown in FIG. 3E.

Using these two setups in FIGS. 3D and 3E, the reflected power could be measured at angles of 0° to 68.99° relative to the specular direction of the reflected signal from the emitter. Specifically, with the panel perpendicular to the emitter direction, the reflected power was measured at angles of 31.76° to 68.99° in increments of 2.48° (FIG. 3D) relative to the specular direction, and with the panel rotated 7.94° from being normal to the emitter direction, the reflected power was measured at angles of 0° to 37.23° (FIG. 3E) relative to the specular direction. While these two configurations have different incident angles, the overlap in data at common angles relative to specular for the two configurations match up well, so that any possible error in combining these data sets is low. The total integrated reflected power over all angles can be calculated from the angular data, as well as the specular fraction of this reflected power.

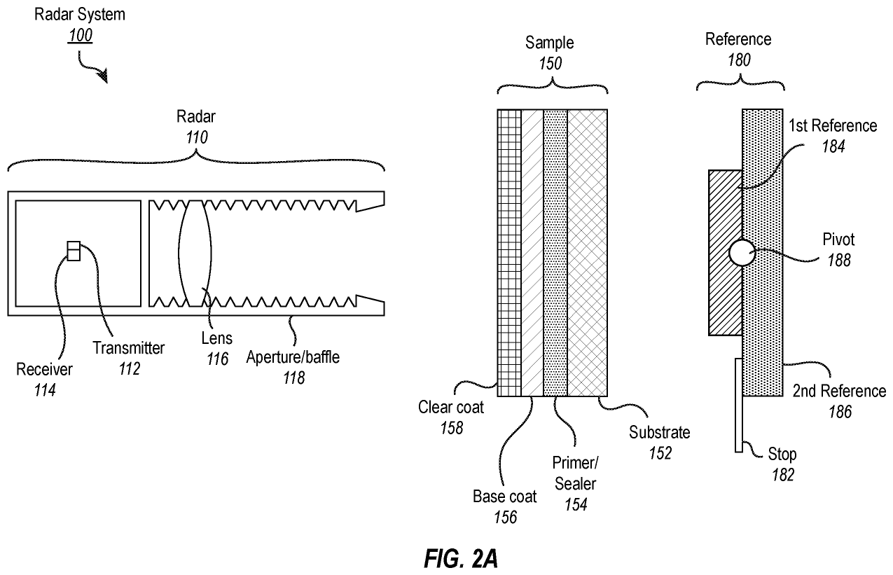

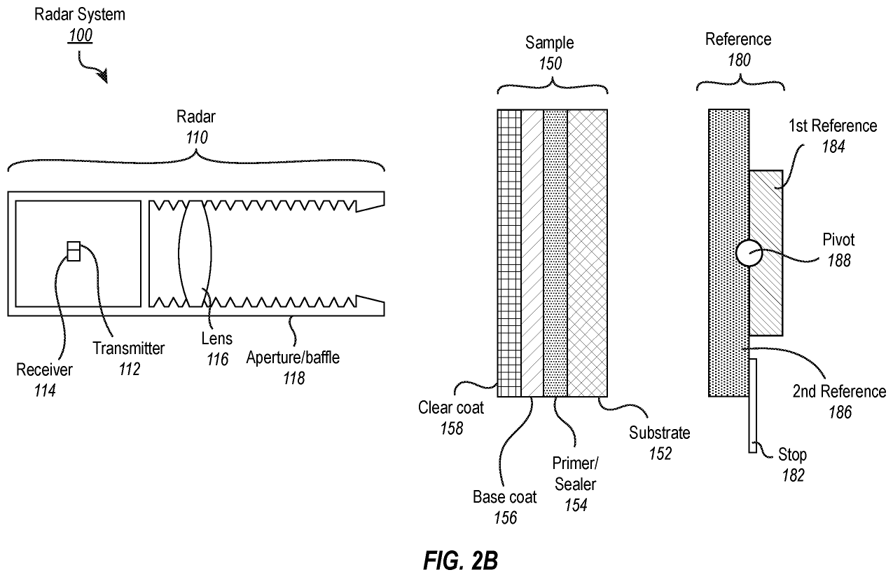

FIG. 2A illustrates an example of the radar system 100 in which the reference 180 includes two sides, including a first reference material 184 on the first side and a second reference material 186 on the second side. A pivot 188 is mounted in the middle, such that for a first measurement the reference 180 is oriented as shown in FIG. 2A to measure the reflected power using the first reference material 184. As illustrated a stop 182 can be employed to maintain the reference 180 at a desired angle. Then, the reference 180 can be rotated 180 degrees around the pivot 188 to have the opposite orientation.

For example, FIG. 2B shows the rotated reference 180 with the first reference shown now rotated to the opposite side as in FIG. 2A. In this second orientation, a second measurement can be performed to measure the reflected power using the second reference material 186. A sensor in the pivot 188 can be used to automatically detect and record which of the two reference materials is being used for a given measurement.

In addition, the reference 180 can be oriented to create a signal “deflector.” In other words, to maximize study of a reflection that is only from sample 150, an end user may wish to deflect (or divert) any reflection from any component (reference 180, or some other object) behind sample 150. In one example, reference 180 can be oriented (e.g., via pivot 188) to deflect its reflection at an angle that is sufficiently away from the return path, such as by angling reference 180 at 45° instead of at 90°, as currently oriented in the Figures. In such a case, the transmitted beam may be deflected using a reference 180, or alternatively via an optional or other deflector element, such as a radar mirror. For example, reference 180 may comprise a radar mirror, or the end user may place a radar mirror in front of reference 180 but angle it appropriately to fully deflect the signal. Whether by rotating reference 180, or using another element appropriately angled to deflect the beam, the “deflector” prevents the transmittted radar beam from going back through sample 150. Then using these two measured reflectance values, Rₘ and Rₛ, and knowing the reflectance of the first calibrated reference, the transmittance of the sample 150 can be calculated.

FIG. 3A illustrates an example in which the transmitter 112 emits two polarizations of electromagnetic radiation. After the sample 150, a polarizer 170 directs the two polarizations to different references: (1) reference 180 and (2) absorber 190 (or a second reference). In the radar 110, a polarizer 120 is used to separately measure the powers for the two polarizations. Thus, both references can be measured simultaneously, rather than requiring two separate measurements.

FIG. 3B illustrates another example in which the radar system 100 uses a different collimating element 116 element 116 and a different aperture/baffle 118. Here, the collimating element 116 element 116 is an off-axis parabolic reflector, and the aperture/baffle 118 is an iris diaphragm. This illustrates just a few nonlimiting examples available to a person of ordinary skill in the art, and that are within the scope of this disclosure. In another example, the collimating element 116 element 116 can use a phased array of transmitting antennas that interfere with each other to produce a lobe that is a collimated beam that is parallel to within sufficient tolerance, such as +a few degrees.

In certain nonlimiting examples of the disclosed radar system 100, the references can be selected to provide improved accuracy of the measurement of transmission through a sample. As discussed above, the measurement process includes measuring the reflected power using two different references 180. In one example, the two references 180 preferably include one reference that is highly reflective, such as a radar mirror, a metal plate, or a metalized adhesive film. The second reference 180 preferably is highly absorptive, such as a radar absorber, or an adhesive film made with radar absorbing material(s). Using these two references, a user places a transmitting end of a handheld radar device onto the sample, such that the end of the pathway section is flush with the sample surface, and then measuring the reflected signal when one of the references is at the far side of the sample. As used herein, the term “flush” means that the reference is either in contact with the sample or is separated from the sample a sufficiently small difference as to have the same or similar effect. It is not necessary that the sample 150 be held in any sort of sample holder. The radar device 110 is self-contained and can simply be placed flush to the sample 150, and a calibrated reference may also similarly be self-contained and can be placed or adhered to the other side of the sample 150. Similarly, a radar receiver, may be placed at an appropriate distance from the side of the sample opposite the radar transmitter.

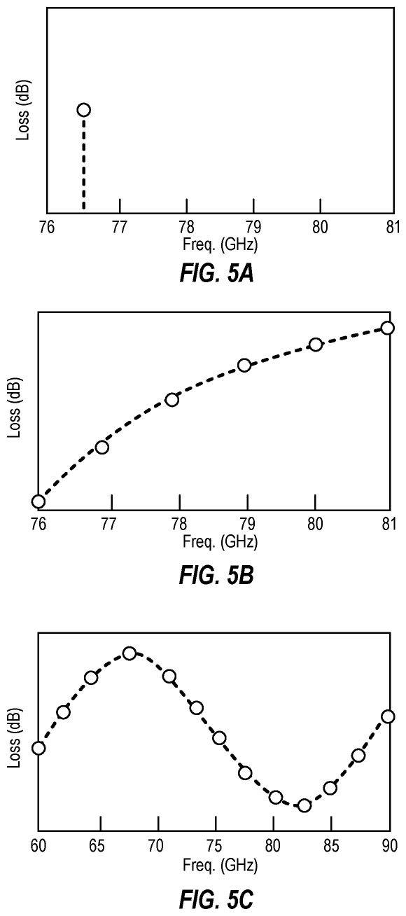

As discussed above, the transmissivity is independent of which direction the radar beam passes through the sample, and therefore it does not matter if the coatings stack side of the sample is facing toward or away from the radar unit. The process is then repeated with the handheld radar device placed onto the sample, such that the end of the pathway section is flush with the sample surface, and then measuring the reflected signal when the other reference is at the far side of the sample. Thereafter, the radar system 100 will process the collected signals to provide the reflectance, transmittance, and/or the radar loss in dB of the sample at the signal frequency of the measurement. For example, as illustrated in FIG. 5A, the radar system 100 can provide transmittance in dB as at the frequency 76.5 GHz.

FIG. 3C provides a still further alternative configuration for a disclosure of a radar reflectivity measurement device. In particular, FIG. 3C illustrates a sequential diagram of a radar system 300 that employs a radar integrating sphere 218 to send, reflect, and receive various radar signals through various apertures 260. In general, the integrating sphere 218 is essentially a closed system, which is illustrated in in this case as a spherical form, however, other shapes may be possible. In principle, the integrating sphere 218 captures reflected electromagnetic radiation 235 due to an emitted beam 230 from radar emitter 212 directed into the interior of the sphere, with the initial incident beam and all reflected beams from the multiple reflections from the sphere wall 220b that impinge on the test sample 150 from multiple directions being received by the radar receiver 260c, to quantify the reflectance of the test sample 150.

The integrating sphere 218 comprises an outer surface 220a and an inner surface 220b. The integrating sphere 218 may comprise any number of materials or compositions; however, preferred materials are those that maximize reflection from the interior surface 220b, such as metal or metallic materials. The use of integrating spheres 218 as a general principle is well known in the optical regime (such as for wavelengths from about 250 nm to 2500 nm), but not traditionally for radar. At least one principle addressed by a radar-oriented integrating sphere (i.e., 218) is to create a diffuse reflecting surface 220b on the interior of a spherical cavity. In at least one example, the interior surface 220b of the spherical cavity may have a high reflectivity, and it should be as diffusely reflective (scattering) as possible at the frequency range of the radar emitter 212 and radar receiver 214. In one configuration, therefore, the integrating sphere may comprise a lightweight metal shell, or may comprise shell of other materials, such as a plastic (e.g., polycarbonate, PET, PETG, or acrylic) shell, which is nevertheless lined on the inside with a metallic coating or other highly reflective coating, such as a metallic foil. A metallic lining on the outside of the sphere may also ensure that the sphere is completely reflective, and not at all transmissive to the emitted radar, as needed for accurate measurement.

FIG. 3C (left side) further shows that the integrating sphere 218 has several apertures 260 (i.e., apertures 260a, 260b, and 260c) in which an end user may position various elements. For example, FIG. 3C shows that the user can position a radar emitter 212 at a first aperture 260a, a test sample against the second aperture 260b. This could take the form of the end user placing a test sample against the aperture 260b, or, in the case of a portable integrating sphere 218 the end user may simply position the integrating sphere 218 directly on the substrate of interest (e.g., sample 150, or another coated element, bumper fascia, body panel, etc.). FIG. 3C further shows that the integrating sphere 218 has a third aperture 260c, in which the user or assembler may position a radar receiver 214. FIG. 3C additionally shows that the integrating sphere 218 can include a baffle 205. The baffle 205 can be configured in at least one configuration to minimize or eliminate directly radiation from radar emitter 212 into the radar receiver 214.

The use of baffle 205 in this regard can help ensure that the only radar emissions entering radar receiver 214 are those that at first were directed to test sample 150, i.e., from a signal emitted through aperture 260a to aperture 260b, as shown in the right side of the sequential diagram of FIG. 3C. Along these lines, FIG. 3C (right side) further shows that the radar beam 230 transmitted from radar emitter 212 can go directly to the test sample 150 positioned at aperture 260b. Upon hitting test sample 150, the emitted signal 230 reflects and bounces around the internal surface 220b of integrating sphere 218 via various reflected beams 235. Eventually the reflected beams 235 bound into radar receiver 214, thus providing a measurement of radar reflectivity of test sample 150. Therefore, a radar integrating sphere, such as radar integrating sphere 218, can be demonstrated to have internal surfaces 220b that are both highly reflective surfaces as well as diffusely reflective surfaces for the radar range of 76 GHz to 81 GHz.

As with radar system 100, radar system 300 using a radar integrating sphere 218, may also employ the use of known references to measure the reflectance, transmittance, and radar loss in dB of the test sample. In fact, as the radar system 300 measures the total reflectance of the test sample, meaning both the specular and diffuse reflection from all angles is being received in the radar receiver, use of a radar integrating sphere is particularly helpful for accurate measurements, because of precise alignment constraints which may occur if only specular radar signals can be received in the reflection measurements.

### Example Measurements with an Integrating Sphere

### Example 1

Metallic surfaces are very good reflectors of electromagnetic waves, such as radar waves. We measured the reflected radar power as a function of angle for an aluminum panel (ALM6061T6, ACT Test Panels LLC, cut to 4 inches×6 inches and which is 0.0305 inches thick). using an angular reflected radar power setup to determine wall reflectance WR and specular fraction s, where s is the ratio of specular reflected power divided by the total power reflected over all angles. See Table 3. Table 3 reports the calculated absolute value of the % error in measurement of reflectance using a hypothetical integrating sphere with given WR and s characteristics for the sphere wall using the data from L. M. Hansen (“Effects of non-Lambertian surfaces on integrating sphere measurements”, L. M. Hanssen, Applied Optics, Vol. 35, No. 19, 3597-3606) to model the absolute value of the % error as a function of WR and s. The % error is calculated as % error=100 (Ra−Ri)/Ra, where Ra is the actual value of reflectance for a material, (e.g., if measured using an integrating sphere 218 with perfectly Lambertian walls (s=0) and perfect wall reflectance (WR=1)), and Ri is the measured reflectance that would be measured for a material, instead if using imperfect WR and s values.

TABLE 2
Example 2 - containing large aluminum glitter flakes in epoxy resin

| | | Weight |
|---|---|---|
| Ingredients | Description | (g) |
| Epoxy Base | Wondercoat Base-A, | 143.67 |
| | Resin Wonder LLC | |
| Epoxy Hardener | Wondercoat Solidifier-B, | 120.34 |
| | Resin Wonder LLC | |
| Alu*Flake | .125″ Hex CTD Silver Alu*Flake, | 10.15 |
| | Glitterex Corp. | |

TABLE 3
The absolute value of the % error in measurement of reflectance
using a hypothetical integrating sphere with given WR
and s characteristics for the sphere wall.

| | Example | Example |
|---|---|---|
| | 1 | 2 |
| WR | 0.99 | 0.25 |
| s | 0.27 | 0.24 |
| \|% Error\| | 0.09 | 36 |

### Example 2

A surface was made with the intent to have it reflect radar over a variety of angles by casting the formula in Table 2 into a silicone mold of interior dimensions of 17.8 cm×12.8 cm×1 cm, to make a panel of these same dimensions. By design, the large hexagonal flakes in the panel were not all aligned parallel to the panel'se lateral surfaces. Therefore, these hexagonal flakes, measuring 0.125 inches from corner to corner, serve as random reflective surfaces to scatter the radar waves, with the intent to be a more diffusely scattering surface. In addition, aluminum foil was adhered to the back of the panel to ensure opacity to the radar waves.

FIG. 3F illustrates radar power measured over angles relative to the specular direction, while FIG. 3G illustrates radar power, plotted on a log scale, measured over angles relative to the specular direction. The reflected radar power was measured as a function of angle for this aluminum panel of Example 2 using an angular reflected radar power setup to determine WR and s. as in Example 1. See Table 3. While Table 3 and FIG. 3G show that this surface did indeed have an improved diffuse reflectivity (smaller s value) than Example 1, the wall reflectance value was reduced compared to Example 1 (FIGS. 3F and 3G), making Example 2 a poorer choice for the wall of an integrating sphere 218. Surprisingly, just an aluminum surface is an excellent choice for the wall (inner surface 220b) of an integrating sphere 218.

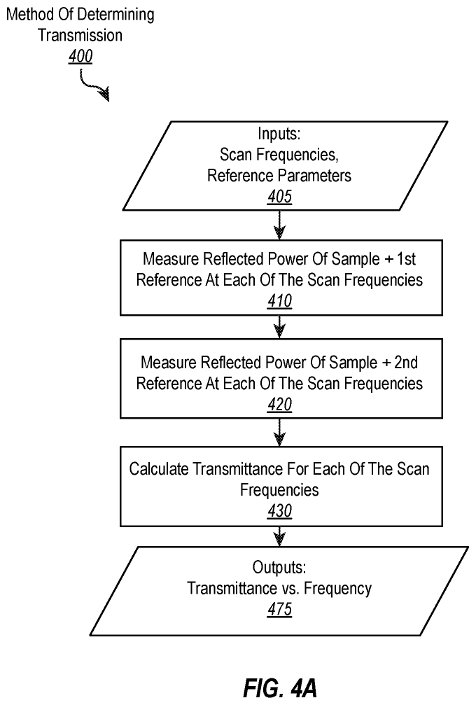

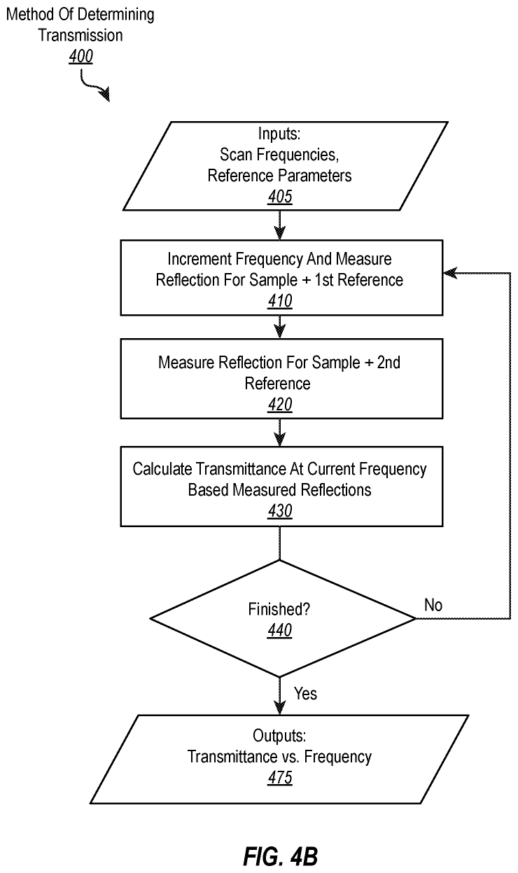

FIG. 4A a flow diagram of a first example of a method 400 for determining the transmission through a sample. The inputs 405 to method 400 are the scan frequencies and reference parameters, including, e.g., the reflectance R_{b,i} of the i^{th} references. Step 410 shows that, for each of the scan frequencies, the reflectance R_{m,1} is measured from the combination of the sample plus the first reference. In step 420, the reflectance R_{m,2} is measured from the combination of the sample plus the second reference, this reflectance R_{m,2} is measured at each of the scan frequencies. In step 430, the transmittance T(ω) at the current scan frequency ω is calculated for the sample 150 at each of the scan frequencies. Finally, the output 475 is the transmittance T(ωvalues versus frequency.

FIG. 4B a flow diagram of a second example of method 400 for determining the transmission through a sample. The inputs 405 to method 400 are the scan frequencies and reference parameters, including, e.g., the reflectance Rbi of the references. Steps 410-440 are a loop that is repeated for each of the scan frequencies. Step 410 shows that the scan frequency can be incremented and the reflectance R_{m,1} is measured for the first reference. In step 420, the reflectance R_{m,2} is measured for the second reference at the current scan frequency. In step 430, the transmittance T(ω) at the current scan frequency ω is calculated for the sample 150. In step 440, if transmittance T(ω) is calculated for all the scan frequencies, then the outputs (i.e., the transmittance T(ω) values versus frequency) are output. Otherwise, the loop consisting of steps 410-440 is repeated for a next scan frequency.

FIGS. 5A-C illustrate examples of plots for the transmittance T(ω) values versus frequency for three nonlimiting example cases. FIG. 5A illustrates the case discussed above in which the transmission is measured as a single frequency (e.g., 76.5 GHZ). This example can be efficient because the collision avoidance radar or other radar might be specified at a single frequency.

FIG. 5B illustrates a case in which the transmittance is measured at six frequencies that are evenly distributed with a period of 1 GHz from 76 GHz to 81 GHz. As discussed below, the radar 110 can be assembled with a transmitter 112 and receiver 114 (e.g., the transmitter and receiver can be antennas, such a microstrip antennas, strip-line antennas, dipole antennas), as well as a signal processor 620, such as a computer processing unit that can evaluate the output power and input power to calculate the reflectance, transmittance, and or the one-way radar loss in units of dB for the radar signal passing through the sample. In this example, the radar 110 operates at a frequency range of 76 to 81 GHz with frequency intervals of 1 GHz. That is, the radar system 100 measures the transmittance at frequencies of 76, 77, 78, 79, 80, and 81 GHz. Alternatively, the radar system 100 could measure the transmittance at frequency intervals of 0.5 GHZ, or at frequency intervals of 0.1 GHz. The elements of the radar system 100 are discussed above, and therefore need not be repeated here.

The measurement process corresponding to FIG. 5B includes measuring the reflected power of two different references, as described above. For the first reference, the radar 110 may be placed onto the sample, such that the transmitting end is flush with the first surface of the sample 150. The first reference is placed next to (e.g., flush with) the second surface of the sample 150. Then, the reflected signal can be measured.

Next, a second reflected signal is measured using a second reference. The second reference replaces the first reference next to the second surface of the sample 150, That is, the second reference is used to generate the second reflected signal by placing the radar 110 onto the sample, such that the transmitting end is flush with the first surface of the sample 150. Then, the reflected signal is measured with the second reference placed next to the second surface of the sample 150. The reflected powers can be measured and stored for all frequencies using the first reference before transitioning to measure the reflected power for all frequencies using the second reference.

Then the radar unit will process the collected signals to provide the reflectance, transmittance, and or the radar loss in dB of the sample at each frequency within the frequency range of the measurement from 76 to 81 GHz. The processor could calculate the reflectance, transmittance, and the one-way radar loss in dB using the same steps discussed above, except the reflectance, transmittance and one way radar loss would be measured at each frequency within the frequency range of the measurement (e.g., 76 to 81 GHZ). As discussed above, the scan frequencies can be 76, 77, 78, 79, 80, and 81 GHz. In another example, the scan frequencies can be each frequency between 76 to 81 GHz at 0.5 GHz intervals. In a third example, the scan frequencies can be each frequency between 76 to 81 GHz at 0.1 GHz intervals. Scanning over a range of frequencies can be advantageous because by so doing the sample 150 can be characterized over the full automotive radar frequency range of 76 to 81 GHz.

The example illustrated in FIG. 5C is like that of FIG. 5B, except the characterization of the transmittance is performed over a wider range of frequencies. In particular, the etalon effect of the sample 150 can be observed in which the transmittance is characterized by a sinusoidal variation as a function of frequency. Here, the frequency range (i.e., 60 GHz to 90 GHz) has been selected large enough to span approximately one half period (or more) of this sinusoidal variation. The frequency interval between measurements can be evenly distributed, e.g., in intervals of 2.5 GHZ, as illustrated in FIG. 5C, or in 1 GHz intervals, or in some other frequency interval. The advantage of this large frequency range for the characterization of the transmittance is that a larger range allows improved characterization of the sample 150.

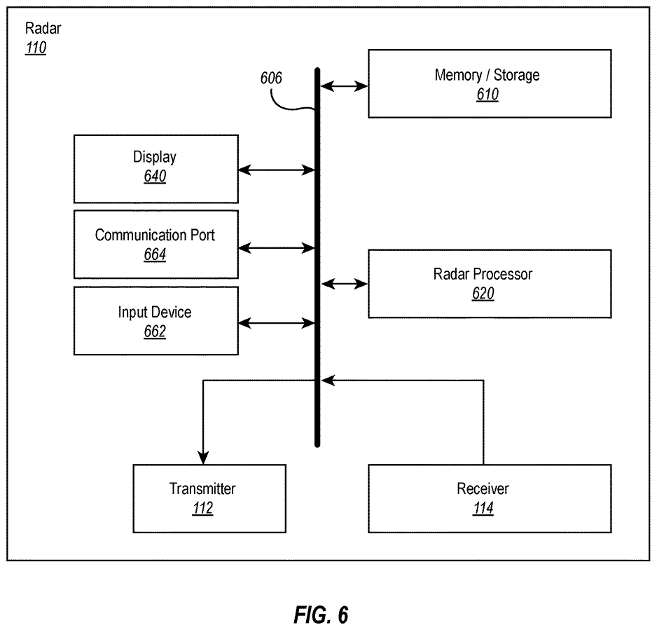

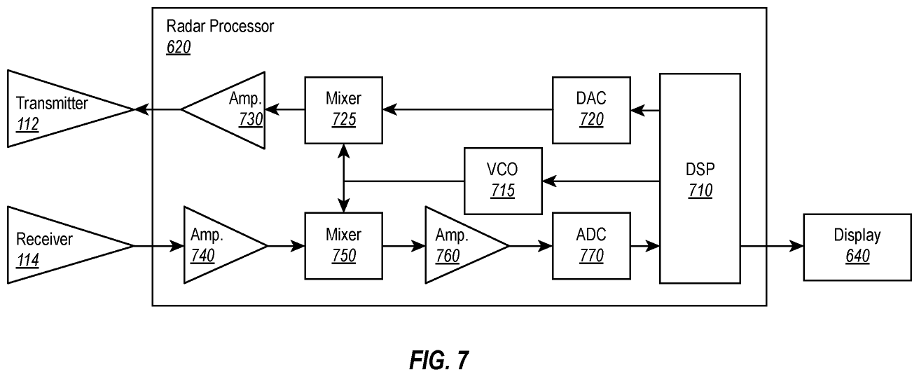

FIG. 6 illustrates a block diagram of the radar 110 illustrating the functional components of the radar 110. The radar 110 includes an input device 662, such as a touch screen, mouse, or keypad that has various controls for enabling a user to operate the device. The input device 662 may have keypads and other input devices for entering information and selecting options for operating the device. The input device 662 is connected to a radar processor 620 via a bus 606. The radar processor conducts general control of the device, and also carries out the radar functionality, including generating transmission signals and processing reception signals to generate power information and to calculate therefrom transmittance information. That transmittance information can be used to display information on the display 640. The radar processor 620 can operate the display 640 directly. Alternatively, the radar processor 620 could pass its generated output to another processor that could use the output to operate the display 640 to display the indicia of the transmittance information (e.g., a green light indicating the transmittance is within design specifications and a red light if not). The function of the radar processor 620 will be described in further detail with reference to FIG. 7.

The radar processor 620 also connects to the transmit antenna 112 and receive antenna 114. The transmit antenna 112 transmits electromagnetic signals generated by the radar processor, and the receive antenna 114 receives the reflected signals and passes the received signals to the radar processor 620.

The radar 110 also includes a memory/storage 610 that stores executable code for performing various processes including method 400 disclosed herein. The radar 110 optionally includes a communication port 664 that is used to update firmware and provide other communications. For example, the radar can communicate with a smart device such as a smartphone using BLUETOOTH or another wireless protocol, for example. The smart device can include an app that obtains information from the radar and performs various methods and functions described herein. Alternatively, the methods and functions could be performed using cloud computing by connecting the radar to a network via the communication port 664.

FIG. 7 shows a block diagram of one example of the radar processor 620, which can be used in the radar 110. It will be appreciated that any type of radar operating at the specified frequency range could be used in the device, including, e.g., a magnetron providing pulse radar functionality, solid state radar providing pulse radar functionality, or a solid-state radar providing a desired modulation functionality.

FIG. 7 shows the components of the radar processor 620. The radar processor 620 includes a digital signal processor (DSP) 710 that controls the frequency of the voltage controlled oscillator (VCO) 715, which provides an intermediate frequency (IF) signal. The DSP 710 also generates a digital signal, and the digital-to-analog converter 720 convert the digital signal to an analog baseband signal (which is shortened to just baseband signal). The mixer 725 mixes the IF and baseband signals to generate a transmit signal, according to a predefined modulation scheme. The power amplifier 730 amplifies the transmit signal before transmitting it via a transmit antenna (i.e., the transmitter 112). The receiver 114 (e.g., a receive antenna) receives a reflected signal and passes this reflected signal to a low noise amplifier 740 in the radar processor 620 that amplifies the received signal. A mixer 750 mixes the amplified signal with the IF signal to generate a received baseband signal, which is then amplified by amplifier 760. The analog to digital converter (ADC) 770 digitizes the analog baseband signal and passes this to the DSP 710.

The DSP 710 performs various processing the received digital signal, including, e.g., matched filtering converting the signal from the time domain to the frequency domain via a fast Fourier transform (FFT) of the received signal. Other processing and filtering can be performed by the DSP 710 to further improve the signal-to-noise ratio.

The following discussion is intended to provide a brief, general description of a suitable computing environment in which the disclosure may be implemented. Although not required, the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the disclosure may be practiced in network computing environments with many types of computer system configurations, including personal computers, hand-held devices, multi-processor systems, microprocessor-based or programmable consumer electronics, network PCs, minicomputers, mainframe computers, and the like. The disclosure may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present disclosure may comprise or utilize a special-purpose or general-purpose computer system that includes computer hardware, such as, for example, one or more processors and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present disclosure can also be described in terms of various configurations and alternate configurations that can be combined and substituted in various ways to accomplish the objectives outlined herein. For example, at least one configuration of the present disclosure can include a radar device that includes a transmitter configured to emit a diverging beam of electromagnetic radiation having a wavelength greater than one millimeter, and in the following configurations up to a maximum wavelength, wherein the diverging beam is emitted along a transmission path to a sample; a first calibrated reference arranged downstream from a location of the sample, the first calibrated reference configured to reflect the directed beam to a return path that is substantially antiparallel, particularly antiparallel, to the transmission path to the sample, the return path passing back through the location of the sample; a receiver arranged on a same side as the transmitter relative to the location of the sample, the receiver configured to measure reflected electromagnetic radiation that has been reflected along the return path, the receiver generating a first measurement value representing a power of the measured electromagnetic radiation; and a processor configured to calculate a transmittance through the sample based on the first measurement value.

In an additional or alternative configuration, the device further includes a collimating element configured to collimate the diverging beam, thereby creating a collimated beam; wherein the collimating element focuses the collimated beam to the location of the sample. In an additional or alternative configuration, the device further includes an aperture arranged between the receiver and the location of the sample; wherein the aperture restricts a solid angle of the measured electromagnetic radiation. In an additional or alternative configuration, the device further includes a second calibrated reference arranged downstream from the location of the sample and configured to be swapped with the first calibrated reference, wherein the receiver measures the electromagnetic radiation that has been reflected along the return path and generates a second measurement value representing a power of the measured electromagnetic radiation, wherein: the processor is further configured to calculate the transmittance through the sample based on the first measurement value, the second measurement value, and calibration values respectively representing measured powers of electromagnetic radiation reflected from the first calibrated reference and the second calibrated reference in an absence of the sample.

In an additional or alternative configuration, the device further includes a deflector arranged to selectively deflect the collimated beam away from the first calibrated reference such that, when the collimated beam is deflected, the receiver generates a second measurement value representing a power reflected from the sample to be measured in an absence of a power that has been twice transmitted through the sample and reflected from the first calibrated reference, wherein the processor is further configured to calculate the transmittance through the sample based on the first measurement value, the second measurement value, and a calibration value representing a measured power of electromagnetic radiation reflected from the first calibrated reference in an absence of the sample.

In an additional or alternative configuration, the transmitter comprises an antenna; the collimating element is a dielectric, a convex lens, a concave reflector, or an off-axis, parabolic reflector; and the receiver is configured to measure an amplitude of the reflected electromagnetic radiation, and the receiver measures the reflected electromagnetic radiation using coherent or incoherent detection. In an additional or alternative configuration, one of: the first calibrated reference is located at a position flush with a second surface of the sample, the second surface being a farthest surface of the sample from the transmitter, or the first calibrated reference is located at a position spaced more than ten wavelengths of the electromagnetic radiation from the second surface. In an additional or alternative configuration, the first calibrated reference comprises a first material that is a reflective material, a radar mirror, a metal, or a combination thereof; and the second calibrated reference comprises a first material that is a partial absorber, a diffuse scatterer, a Lambertian scatterer, a dielectric material, or a combination thereof.

In an additional or alternative configuration, the device can include a polarizer located between the location of the sample and the first calibrated reference, wherein: the receiver is configured to measure reflected electromagnetic radiation corresponding to a first polarization to generate the first measurement value, the receiver is configured to measure to reflected electromagnetic radiation corresponding to a second polarization to generate a second measurement value, and the processor is further configured to calculate the transmittance through the sample based on the first measurement value, the second measurement value, and calibration values respectively representing measured powers of the first and second polarizations of electromagnetic radiation reflected from the first calibrated reference in an absence of the sample.

In an additional or alternative configuration, the device can further include an integrating sphere having a first aperture for positioning the transmitter, a second aperture for positioning the receiver, and a third aperture for positioning the sample in line with the transmitter; wherein: the integrating sphere at least partially diffuses the electromagnetic radiation reflected by the sample within the integrating sphere to produce hemispherical reflected electromagnetic radiation, and the receiver detects the hemispherical reflected electromagnetic radiation. In an additional or alternative configuration, the integrating sphere comprises an inner surface and an outer surface; and the inner surface comprises a continuous metallic surface. In an additional or alternative configuration, the device can further include a baffle positioned between the transmitter and the receiver within the integrating sphere; wherein the baffle blocks direct transmission from the transmitter to the receiver.

In addition to the foregoing, another configuration of the present disclosure can include a radar device that includes a transmitter configured to emit a diverging beam of electromagnetic radiation having a wavelength greater than one millimeter, wherein the diverging beam is emitted along a transmission path to a sample, the sample having a front surface and an opposed, rear surface; a receiver arranged adjacent the rear surface of the sample, the receiver configured to measure transmitted electromagnetic radiation that has been transmitted through the sample, the receiver generating a first measurement value representing a power of the measured electromagnetic radiation transmitted through the sample; and a processor configured to calculate a transmittance through the sample based on the first measurement value. In an additional or alternative configuration, the device can further include a first gain horn antenna arranged between the transmitter and the location of the sample; wherein the first gain horn antenna is positioned adjacent the front surface of the sample. In an additional or alternative configuration, the device can further include a second gain horn antenna arranged adjacent an opposing rear surface of the sample; wherein the second gain horn antenna receives the emitted beam after the emitted beam has passed through the front surface of the sample.

In an additional or alternative configuration, the second gain horn antenna receives the emitted beam via a diverting or guiding element coupled with the first gain horn antenna. In an additional or alternative configuration, the device can further include a self-alignment tool configured to align the transmission path of the beam from the transmitter on the front surface of the sample to the receiver positioned on the rear surface of the sample. In an additional or alternative configuration, the self-alignment tool further includes a first portion comprising a first magnet, and a second portion comprising a second magnet; and the second magnet is drawn to the first magnet through the sample, thereby aligning the transmission path from the transmitter on the front side of the sample to the receiver on the rear side of the sample. In an additional or alternative configuration, the processor is configured to control a frequency of the electromagnetic radiation to measure the first measurement value over a range of frequencies from 76 GHz to 81 GHz, and to calculate therefrom the transmittance over the range of frequencies from 76 GHz to 81 GHz. In an additional or alternative configuration, the processor is configured to control a frequency of the electromagnetic radiation to measure the first measurement value over a range of frequencies from 60 GHz to 90 GHz, and to calculate therefrom the transmittance over the range of frequencies from 60 GHz to 90 GHz.

Still further configurations of the present disclosure can include one or more methods. In one example, a method of determining a transmittance through a sample may include emitting a diverging beam of electromagnetic radiation from a transmitter, the electromagnetic radiation having a wavelength greater than one millimeter; directing the diverging beam along a transmission path to a sample at a location; reflecting the electromagnetic radiation from a first calibrated reference arranged downstream from the location of the sample, the first calibrated reference configured to direct the reflected electromagnetic radiation to a return path that is substantially antiparallel, particularly antiparallel, to the transmission path, the return path passing through the location of the sample; detecting the reflected electromagnetic radiation using a receiver arranged on a same side as the transmitter relative to the location of the sample, the receiver configured to measure reflected electromagnetic radiation that has been reflected along the return path, the receiver generating a first measurement value representing a power of the measured electromagnetic radiation; and calculating, using a processor, a transmittance through the sample based on the first measurement value. In an additional or alternative configuration, the method can further include blocking extraneous signals and/or noise using an aperture arranged between the receiver and the location of the sample, wherein the aperture is configured to restrict a solid angle of the measured electromagnetic radiation.

In an additional or alternative configuration, the method can further include measuring a second measurement value using a second calibrated reference arranged downstream of the location of the sample, and configured to be swapped with the first calibrated reference, wherein the receiver measures the electromagnetic radiation that has been reflected from the second calibrated reference along the return path and generates the second measurement value representing a power of the measured electromagnetic radiation, wherein: the processor is further configured to calculate the transmittance through the sample based on the first measurement value, the second measurement value, and calibration values respectively representing measured powers of electromagnetic radiation reflected from the first calibrated reference and the second calibrated reference in an absence of the sample. In an additional or alternative configuration, the method can further include: measuring a second measurement value using a deflector arranged to selectively deflect a collimated beam away from the first calibrated reference such that, when the collimated beam is deflected, the receiver generates the second measurement value representing a power reflected from the sampled to be measured in an absence of a power that has been twice transmitted through the sample and reflected from the first calibrated reference, wherein: the processor is further configured to calculate the transmittance through the sample based on the first measurement value, the second measurement value, and a calibration value representing a measured power of electromagnetic radiation reflected from the first calibrated reference in an absence of the sample.

In an additional or alternative configuration, the transmitter is a phased-array antenna or a dipole antenna, a collimating element is a dielectric, a convex lens, a concave reflector, or an off-axis, parabolic reflector, the receiver measures at least one of (i) an amplitude and (ii) a phase of the reflected electromagnetic radiation, and the receiver measures the reflected electromagnetic radiation using homodyne or heterodyne detection. In an additional or alternative configuration, one of: the first calibrated reference is located at a position flush with a second surface of the sample, the second surface being a farthest surface of the sample from the transmitter, or the first calibrated reference is located at a position spaced more than ten wavelengths of the electromagnetic radiation from the second surface. In an additional or alternative configuration, the processor is configured to control a frequency of the electromagnetic radiation to measure the first measurement value over a range of frequencies from 76 GHz to 81 GHz, and to calculate therefrom the transmittance over the range of frequencies from 76 GHz to 81 GHz.

In an additional or alternative configuration, the processor is configured to control a frequency of the electromagnetic radiation to measure the first measurement value over a range of frequencies from 60 GHz to 90 GHz, and to calculate therefrom the transmittance over the range of frequencies from 60 GHz to 90 GHz. In an additional or alternative configuration, the method can further include attenuating a first polarization of the electromagnetic radiation using a polarizer located between the location of the sample and the first calibrated reference, wherein the receiver is configured to measure reflected electromagnetic radiation corresponding to a first polarization to generate the first measurement value, the receiver is configured to measure reflected electromagnetic radiation corresponding to a second polarization to generate a second measurement value, and the processor is further configured to calculate the transmittance through the sample based on the first measurement value, the second measurement value, and calibration values respectively representing measured powers of the first and second polarizations of electromagnetic radiation reflected from the first calibrated reference in an absence of the sample.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1-29. (canceled)

30. A radar device, comprising:
a transmitter configured to emit a diverging beam of electromagnetic radiation having a wavelength greater than one millimeter, wherein the diverging beam is emitted along a transmission path to a sample;
a first calibrated reference arranged downstream from a location of the sample, the first calibrated reference configured to reflect the directed beam to a return path that is substantially antiparallel to the transmission path to the sample, the return path passing back through the location of the sample;
a receiver arranged on a same side as the transmitter relative to the location of the sample, the receiver configured to measure reflected electromagnetic radiation that has been reflected along the return path, the receiver generating a first measurement value representing a power of the measured electromagnetic radiation; and
a processor configured to calculate a transmittance through the sample based on the first measurement value.

31. The radar device of claim 30, further comprising:
a collimating element configured to collimate the diverging beam, thereby creating a collimated beam;
wherein the collimating element focuses the collimated beam to the location of the sample.

32. The radar device of claim 30, further comprising:
an aperture arranged between the receiver and the location of the sample;
wherein the aperture restricts a solid angle of the measured electromagnetic radiation.

33. The radar device of claim 32, further comprising:
a deflector arranged to selectively deflect the collimated beam away from the first calibrated reference such that, when the collimated beam is deflected, the receiver generates a second measurement value representing a power reflected from the sample to be measured in an absence of a power that has been twice transmitted through the sample and reflected from the first calibrated reference, wherein
the processor is further configured to calculate the transmittance through the sample based on the first measurement value, a second measurement value, and a calibration value.

34. The radar device of 33, further comprising:
a second calibrated reference arranged downstream from the location of the sample and configured to be swapped with the first calibrated reference, wherein the receiver measures the electromagnetic radiation that has been reflected along the return path and generates the second measurement value representing a power of the measured electromagnetic radiation,
wherein:
the processor is further configured to calculate the transmittance through the sample based on the first measurement value, the second measurement value, and calibration values respectively representing measured powers of electromagnetic radiation reflected from the first calibrated reference and the second calibrated reference in an absence of the sample.

35. The radar device of 34, wherein:
the transmitter comprises an antenna;
the collimating element is a dielectric, a convex lens, a concave reflector, or an off-axis, parabolic reflector; and
the receiver is configured to measure an amplitude of the reflected electromagnetic radiation, and the receiver measures the reflected electromagnetic radiation using coherent or incoherent detection.

36. The radar device of claim 34, wherein one of:
the first calibrated reference is located at a position flush with a second surface of the sample, the second surface being a farthest surface of the sample from the transmitter, or
the first calibrated reference is located at a position spaced more than ten wavelengths of the electromagnetic radiation from the second surface.

37. The radar device of claim 30, wherein:
the first calibrated reference comprises a first material that is a reflective material, a radar mirror, a metal, or a combination thereof; and
the second calibrated reference comprises a first material that is a partial absorber, a diffuse scatterer, a Lambertian scatterer, a dielectric material, or a combination thereof.

38. The radar device of claim 30, further comprising:
a polarizer located between the location of the sample and the first calibrated reference, wherein:
the receiver is configured to measure reflected electromagnetic radiation corresponding to a first polarization to generate the first measurement value,
the receiver is configured to measure to reflected electromagnetic radiation corresponding to a second polarization to generate a second measurement value, and
the processor is further configured to calculate the transmittance through the sample based on the first measurement value, the second measurement value, and calibration values respectively representing measured powers of the first and second polarizations of electromagnetic radiation reflected from the first calibrated reference in an absence of the sample.

39. The radar device of claim 30, further comprising:
an integrating sphere having a first aperture for positioning the transmitter, a second aperture for positioning the receiver, and a third aperture for positioning the sample in line with the transmitter;
wherein:
the integrating sphere at least partially diffuses the electromagnetic radiation reflected by the sample within the integrating sphere to produce hemispherical reflected electromagnetic radiation, and
the receiver detects the hemispherical reflected electromagnetic radiation.

40. The radar device of claim 39, wherein:
the integrating sphere comprises an inner surface and an outer surface; and
the inner surface comprises a continuous metallic surface.

41. The radar device of claim 40, further comprising:
a baffle positioned between the transmitter and the receiver within the integrating sphere;
wherein the baffle blocks direct transmission from the transmitter to the receiver.

42. A radar device, comprising:
a transmitter configured to emit a diverging beam of electromagnetic radiation having a wavelength greater than one millimeter, wherein the diverging beam is emitted along a transmission path to a sample, the sample having a front surface and an opposed, rear surface;
a receiver arranged adjacent the rear surface of the sample, the receiver configured to measure transmitted electromagnetic radiation that has been transmitted through the sample, the receiver generating a first measurement value representing a power of the measured electromagnetic radiation transmitted through the sample; and
a processor configured to calculate a transmittance through the sample based on the first measurement value.

43. The radar device of claim 42, further comprising:
a first gain horn antenna arranged between the transmitter and the location of the sample;
wherein the first gain horn antenna is positioned adjacent the front surface of the sample.

44. The radar device of claim 42, further comprising:
a second gain horn antenna arranged adjacent an opposing rear surface of the sample;
wherein the second gain horn antenna receives the emitted beam after the emitted beam has passed through the front surface of the sample.

45. The radar device of claim 44, wherein the second gain horn antenna receives the emitted beam via a diverting or guiding element coupled with the first gain horn antenna.

46. The radar device of claim 45, further comprising:
a self-alignment tool configured to align the transmission path of the beam from the transmitter on the front surface of the sample to the receiver positioned on the rear surface of the sample.

47. The radar device of claim 46, wherein:
the self-alignment tool further includes a first portion comprising a first magnet, and a second portion comprising a second magnet; and
the second magnet is drawn to the first magnet through the sample, thereby aligning the transmission path from the transmitter on the front side of the sample to the receiver on the rear side of the sample.

48. The radar device of claim 42, wherein the processor is configured to control a frequency of the electromagnetic radiation to measure the first measurement value over a range of frequencies from 76 GHz to 81 GHZ, and to calculate therefrom the transmittance over the range of frequencies from 76 GHz to 81 GHz.

49. A method of determining a transmittance through a sample, the method comprising:
emitting a diverging beam of electromagnetic radiation from a transmitter, the electromagnetic radiation having a wavelength greater than one millimeter;
directing the diverging beam along a transmission path to a sample at a location;
reflecting the electromagnetic radiation from a first calibrated reference arranged downstream from the location of the sample, the first calibrated reference configured to direct the reflected electromagnetic radiation to a return path that is substantially antiparallel to the transmission path, the return path passing through the location of the sample;
detecting the reflected electromagnetic radiation using a receiver arranged on a same side as the transmitter relative to the location of the sample, the receiver configured to measure reflected electromagnetic radiation that has been reflected along the return path, the receiver generating a first measurement value representing a power of the measured electromagnetic radiation;
calculating, using a processor, a transmittance through the sample based on the first measurement value;
blocking extraneous signals and/or noise using an aperture arranged between the receiver and the location of the sample, wherein the aperture is configured to restrict a solid angle of the measured electromagnetic radiation.
